(19) United States
(12) Patent Application Publication
(10) Pub. No.: US 2026/0278282 A1
(43) Pub. Date: Sep. 17, 2026

(54) METHOD FOR EVALUATING TEXT-TO-IMAGE GENERATION, ELECTRONIC DEVICE AND STORAGE MEDIUM

(71) Applicant: Beijing Baidu Netcom Science Technology Co., Ltd., Beijing (CN)

(72) Inventors: Xiaowen Yang, Beijing (CN); Yehua Yang, Beijing (CN); Qiao Zhao, Beijing (CN); Tian Wu, Beijing (CN)

(21) Appl. No.: 19/685,281

(22) Filed: May 22, 2026

(30) Foreign Application Priority Data
Feb. 26, 2026 (CN) 202610231134.7

(51) Int. Cl. G06F 40/30; G06F 40/205; G06T 7/00; G06T 11/60

(52) U.S. Cl. CPC G06F 40/30; G06F 40/205; G06T 7/0002; G06T 11/60; G06T 2207/30168

(57) ABSTRACT

Provided is a method for evaluating text-to-image generation, an electronic device and a storage medium, relating to the field of computer technology, and in particular to the fields of artificial intelligence, generative search, knowledge graph, text-to-image generation and others. The method includes: receiving an evaluation request instruction described in natural language and a target image to be evaluated, wherein the target image is an image correspondingly generated based on a text described in the natural language; when parsing the evaluation request instruction, decomposing the natural language description into multiple pieces of structured semantic information based on intent analysis; obtaining a set of visual question answering tasks for evaluation and verification based on the multiple pieces of structured semantic information in combination with visual analysis of the target image; and performing multi-dimensional evaluation according to the visual question answering tasks to obtain a quantitative evaluation result.

### CROSS-REFERENCE TO RELATED APPLICATIONS

The present application claims priority to Chinese Patent Application No. CN202610231134.7, filed with the China National Intellectual Property Administration on Feb. 26, 2026, the disclosure of which is hereby incorporated herein by reference in its entirety.

### TECHNICAL FIELD

The present disclosure relates to the field of computer technology, and in particular to the fields of artificial intelligence, generative search, knowledge graph, text-to-image generation and others.

### BACKGROUND

With the rapid development of generative artificial intelligence technology, text-to-image generation models have shown increasingly powerful capabilities in image generation tasks. However, the existing methods for evaluating text-to-image generation models are mostly limited to a single indicator and are highly subjective, failing to understand complex “natural language requirement” instructions, resulting in unsatisfactory evaluation results and difficulty in meeting practical application requirements.

### SUMMARY

The present disclosure provides a method and an apparatus for evaluating text-to-image generation, a device and a storage medium.

According to one aspect of the present disclosure, provided is a method for evaluating text-to-image generation, including:
receiving an evaluation request instruction described in natural language and a target image to be evaluated, where the target image is an image correspondingly generated based on a text described in the natural language;
when parsing the evaluation request instruction, decomposing the natural language description into multiple pieces of structured semantic information based on intent analysis;
obtaining a set of visual question answering tasks for evaluation and verification based on the multiple pieces of structured semantic information in combination with visual analysis of the target image; and
performing multi-dimensional evaluation according to the visual question answering tasks to obtain a quantitative evaluation result.

According to another aspect of the present disclosure, provided is an apparatus for evaluating text-to-image generation, including:
an instruction receiving module configured to receive an evaluation request instruction described in natural language and a target image to be evaluated, where the target image is an image correspondingly generated based on a text described in the natural language;
an instruction parsing module configured to, when parsing the evaluation request instruction, decompose the natural language description into multiple pieces of structured semantic information based on intent analysis;
a question answering task generation module configured to obtain a set of visual question answering tasks for evaluation and verification based on the multiple pieces of structured semantic information in combination with visual analysis of the target image; and
an evaluation module configured to perform multi-dimensional evaluation according to the visual question answering tasks to obtain a quantitative evaluation result.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method provided in any embodiment of the present disclosure.

According to yet another aspect of the present disclosure, provided is a non-transitory computer-readable storage medium storing a computer instruction thereon, and the computer instruction is used to cause a computer to execute the method provided in any embodiment of the present disclosure.

According to yet another aspect of the present disclosure, provided is a computer program product including a computer program, and the computer program implements the method provided in any embodiment of the present disclosure, when executed by a processor.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic diagram of a distributed cluster processing scenario according to an embodiment of the present disclosure;

FIG. 2 is a schematic flowchart of a method for evaluating text-to-image generation according to an embodiment of the present disclosure;

FIGS. 3 to 9 are schematic flowcharts of another method for evaluating text-to-image generation according to an embodiment of the present disclosure;

FIG. 10 is a schematic diagram of a workflow of evaluating text-to-image generation in an application example according to an embodiment of the present disclosure;

FIG. 11 is a schematic diagram of the composition structure of an apparatus for evaluating text-to-image generation according to an embodiment of the present disclosure; and

FIG. 12 is a block diagram of an electronic device used to implement the method for evaluating text-to-image generation according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that only A exists, or both A and B exist, or only B exists. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

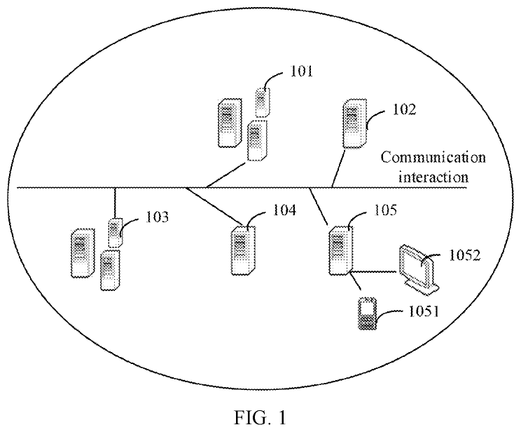

According to an embodiment of the present disclosure, FIG. 1 is a schematic diagram of a distributed cluster processing scenario according to an embodiment of the present disclosure. The distributed cluster system is an example of a cluster system, and an exemplary description is given of a method for evaluating text-to-image generation using the distributed cluster system. The present disclosure is not limited to the method for evaluating text-to-image generation on a single machine or multiple machines. The use of distributed processing can further improve the efficiency of the method for evaluating text-to-image generation. As shown in FIG. 1, the distributed cluster system includes multiple nodes (such as server cluster 101, server 102, server cluster 103, server 104, and server 105 which may also be connected to electronic devices, such as mobile phone 1051 and desktop computer 1052). Multiple nodes or multiple nodes and electronic devices connected thereto can jointly perform one or more evaluation tasks of text-to-image generation. Optionally, multiple nodes in the distributed cluster system may adopt a data parallel processing method, so that multiple nodes can perform the evaluation task of text-to-image generation based on the same processing method. Alternatively, one or more processing logics of the processing method may be deployed in a distributed manner on multiple nodes to cooperate in completing the evaluation task of text-to-image generation.

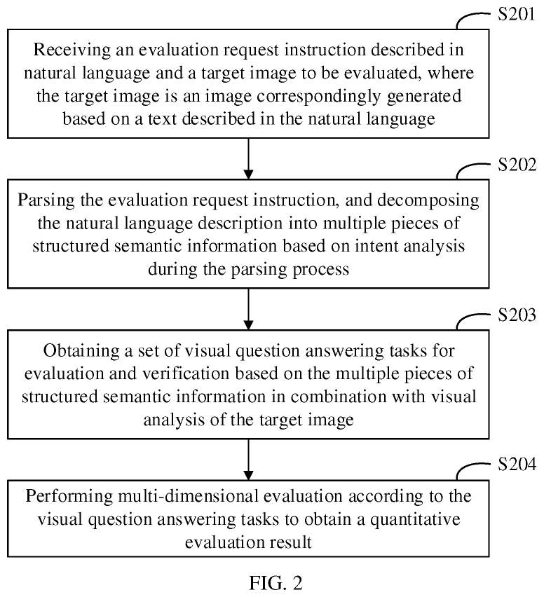

According to an embodiment of the present disclosure, a method for evaluating text-to-image generation is provided. FIG. 2 is a schematic flowchart of the method for evaluating text-to-image generation according to the embodiment of the present disclosure. This method may be applied to an apparatus for evaluating text-to-image generation. For example, this apparatus may be deployed on a terminal, a server or other processing device in a single-machine, multi-machine or cluster system to realize the evaluation task of text-to-image generation. Here, the terminal may be a User Equipment (UE), a mobile device, a Personal Digital Assistant (PDA), a handheld device, a computing device, a vehicle-mounted device, a wearable device, etc. In some possible implementations, the method may also be implemented by the processor calling a computer-readable instruction stored in the memory. As shown in FIG. 2, this method is applied to any node or electronic device in the cluster system shown in FIG. 1, including:

S201: receiving an evaluation request instruction described in natural language and a target image to be evaluated, where the target image is an image correspondingly generated based on a text described in the natural language.

In some examples, a user inputs an evaluation request instruction described in natural language, which may be: evaluate whether the image meets the requirement of the prompt “an orange cat wearing a red bow sits on a sofa”, and simultaneously upload or specify a cat image generated by the text-to-image generation model based on the prompt. The cat image is taken as the target image. By clearly defining the object to be evaluated (the target image) and the reference standard for evaluation (in compliance with the requirement of the evaluation request instruction), an evaluation reference is provided for subsequent evaluation.

S202: parsing the evaluation request instruction, and decomposing the natural language description into multiple pieces of structured semantic information based on intent analysis during the parsing process.

In some examples, the evaluation request instruction is parsed, and the core of the intent analysis thereof is to evaluate the consistency between the target image and the text. The core prompt “an orange cat wearing a red bow sits on a sofa” quoted in the evaluation request instruction is taken as the natural language description to be parsed, and is decomposed into three pieces of structured information, for example: object (cat, sofa), attribute (cat: orange, wearing the red bow), relationship (the cat sits on the sofa), etc.

S203: obtaining a set of visual question answering tasks for evaluation and verification based on the multiple pieces of structured semantic information in combination with visual analysis of the target image.

In some examples, based on the three pieces of structured semantic information obtained in S202, a decision question that requires visual analysis to answer is generated for each piece of structured semantic information. For example, for the attribute information “the cat is orange”, a visual question answering task will be generated: “Is the cat in the picture orange?”. If a further answer is required, the visual model may be called to analyze and judge the color of the cat in the target image.

S204: performing multi-dimensional evaluation according to the visual question answering tasks to obtain a quantitative evaluation result.

In some examples, when all visual question answering tasks are generated according to S203, for example, the total task is broken down into three sub-tasks, and three questions accordingly described are: “Is there a cat?”, “Is the color orange?”, and “Does it wear a bow?”. The answers obtained are: “Yes” (there is a cat), “Yes” (the cat is orange), and “No” (it does not wear a bow), respectively.

In some examples, the comprehensive evaluation may be made based on these answers. For example, a simple quantification method is used to divide the number of correctly answered questions by the total number of questions to get a quantification result: ⅔≈0.67 (or 67%). This score is a quantitative evaluation result of the consistency between text and image. Further, the quantitative evaluation results may also be evaluated using multi-dimensional indicators from both objective and subjective dimensions, which will be elaborated in detail in the subsequent embodiments of quantitative evaluation and will not be repeated here.

In the embodiment of the present disclosure, this embodiment combines the natural language processing technology with the visual analysis technology to achieve the comprehensive, systematic and quantifiable evaluation of the quality of text-to-image generation, and can not only accurately understand the user's intent but also conduct in-depth analysis based on the content of the target image, thereby ensuring the objectivity and accuracy of the evaluation. Moreover, the multi-dimensional evaluation method makes the evaluation result richer and more comprehensive.

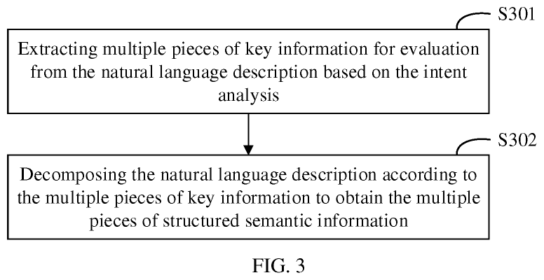

According to an embodiment of the present disclosure, a method for evaluating text-to-image generation is provided. FIG. 3 is a schematic flowchart of the method for evaluating text-to-image generation according to the embodiment of the present disclosure. The step of decomposing the natural language description into multiple pieces of structured semantic information based on intent analysis, as shown in FIG. 3, includes:

S301: extracting multiple pieces of key information for evaluation from the natural language description based on the intent analysis.

In some examples, based on the intent analysis, multiple pieces of key information may be automatically extracted from the prompt “An ancient stone bridge spans across a misty river”. For example, the key information extracted includes: “ancient” (attribute), “stone bridge” (object), “spans across” (relationship), “misty” (attribute), and “river” (object).

S302: decomposing the natural language description according to the multiple pieces of key information to obtain the multiple pieces of structured semantic information.

In some examples, the key information extracted may be organized and structured to form multiple pieces of explicit structured semantic information. For example, the multiple pieces of structured semantic information formed includes: 1) objects: stone bridge and river; 2) attributes: the stone bridge is ancient, and the river is misty; 3) relationship: the stone bridge spans across the river. The evaluation list composed of these structured semantic information forms a clear checklist for subsequent quantitative evaluation.

In the embodiment of the present disclosure, this embodiment details how to decompose the natural language description into multiple pieces of structured semantic information based on the intent analysis. Specifically, the complex natural language description can be efficiently transformed into multiple pieces of structured semantic information through the intent analysis and the extraction of multiple pieces of key information. This method not only improves the accuracy of semantic understanding, but also provides a reliable foundation for subsequent generation of visual question answering tasks, thereby improving the overall evaluation efficiency and evaluation accuracy.

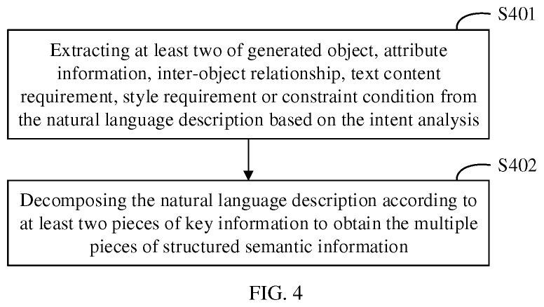

According to an embodiment of the present disclosure, a method for evaluating text-to-image generation is provided. FIG. 4 is a schematic flowchart of the method for evaluating text-to-image generation according to the embodiment of the present disclosure. As shown in FIG. 4, the method includes:

S401: extracting at least two of generated object, attribute information, inter-object relationship, text content requirement, style requirement or constraint condition from the natural language description based on the intent analysis.

S402: decomposing the natural language description according to at least two pieces of key information to obtain the multiple pieces of structured semantic information.

In the embodiment of the present disclosure, this embodiment details how to extract the key information from the natural language description, and specifically extract at least two types of key information from “generated object, attribute information, inter-object relationship, text content requirement, style requirement or constraint condition”, which can comprehensively cover multiple key information dimensions of the evaluation of text-to-image generation. This method not only improves the comprehensiveness of the evaluation, but also provides rich semantic basis for subsequent generation of visual question answering tasks, thereby ensuring the accuracy and reliability of the evaluation result.

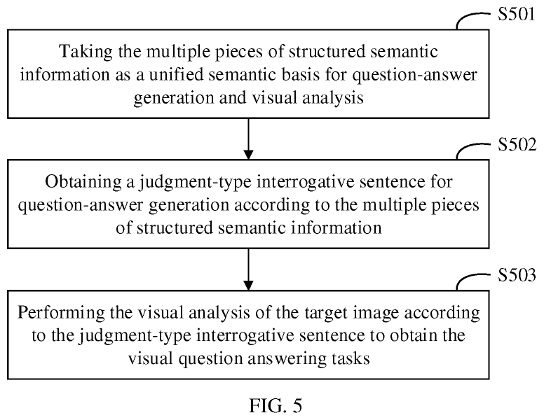

According to an embodiment of the present disclosure, a method for evaluating text-to-image generation is provided. FIG. 5 is a schematic flowchart of the method for evaluating text-to-image generation according to the embodiment of the present disclosure. The step of obtaining a set of visual question answering tasks for evaluation and verification based on the multiple pieces of structured semantic information in combination with visual analysis of the target image, as shown in FIG. 5, includes:

S501: taking the multiple pieces of structured semantic information as a unified semantic basis for question-answer generation and visual analysis.

In some examples, multiple pieces of structured semantic information (for example: object-astronaut, attribute-wear a silver spacesuit, relationship-stand on the lunar surface) may be obtained by extracting multiple pieces of key information from the prompt, and become a common benchmark for all subsequent steps (e.g., question answering generation and visual analysis). In other words, whether generating questions or analyzing images, it is necessary to strictly focus on these information to ensure the pertinence and consistency of the evaluation.

S502: obtaining a judgment-type interrogative sentence for question-answer generation according to the multiple pieces of structured semantic information.

In some examples, based on the unified semantic basis in S501 described above, a question in the form of judgment-type interrogative sentence with the answer “yes/no” may be automatically generated for each piece of verifiable information. For example: 1) “Is there an astronaut in the picture?”; 2) “Does the astronaut wear a silver spacesuit?”; 3) “Does the astronaut stand on the lunar surface?”.

S503: performing the visual analysis of the target image according to the judgment-type interrogative sentence to obtain the visual question answering tasks.

In some examples, a “visual question answering task” may consist of a “question-answer pair”, i.e., explicitly consist of one judgment-type interrogative sentence (which is the question in the form of judgment-type interrogative sentence generated in S502 above) and one visual analysis action for that question. For example, in the case of “question-answer pair”, the task to be performed for the question “Does the astronaut wear a silver spacesuit?” is to call a visual model to analyze the target image to identify the color of the astronaut's suit and judge whether it is silver, thereby generating the corresponding answer to the question “Does the astronaut wear a silver spacesuit?”.

In the embodiment of the present disclosure, this embodiment details how to take the structured semantic information as the unified semantic basis and generate visual question answering tasks in combination with visual analysis. Specifically, the semantic information can be efficiently combined with the image content through the unified semantic basis and the generation mechanism of the judgment-type interrogative sentence. This method not only improves the relevance of visual question answering tasks, but also provides high-quality “question-answer pairs” composed of questions and answers for subsequent evaluation, thereby enhancing the accuracy and efficiency of the overall evaluation.

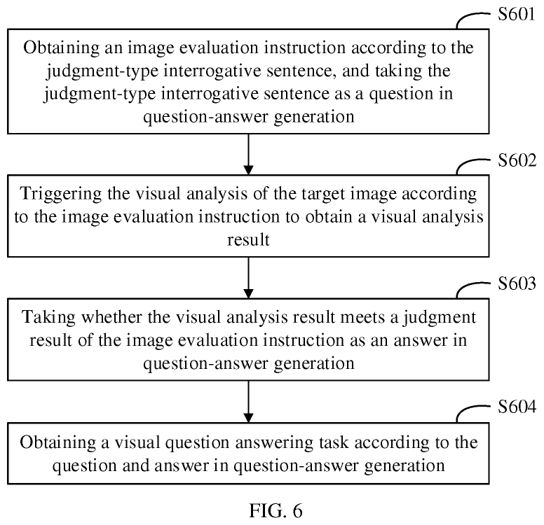

According to an embodiment of the present disclosure, a method for evaluating text-to-image generation is provided. FIG. 6 is a schematic flowchart of the method for evaluating text-to-image generation according to the embodiment of the present disclosure. The step of performing the visual analysis of the target image according to the judgment-type interrogative sentence to obtain the visual question answering tasks, as shown in FIG. 6, includes:

S601: obtaining an image evaluation instruction according to the judgment-type interrogative sentence, and taking the judgment-type interrogative sentence as a question in question-answer generation.

In some examples, the judgment-type interrogative sentence is “Is the apple in the picture placed on a wooden table?”, which inherently contains an image evaluation instruction: “Please check whether the positional relationship between the apple and the wooden table is ‘placed on the wooden table’”. This judgment-type interrogative sentence may be directly used as a “question” to be answered.

S602: triggering the visual analysis of the target image according to the image evaluation instruction to obtain a visual analysis result.

In some examples, in response to the image evaluation instruction in S601 above, the visual model such as object detection or scene graph generation may be used to analyze the image. The visual analysis result obtained after the visual analysis may be the detected objects “apple” and “table”, as well as the predicted relationship label “on” or “near” between them.

S603: taking whether the visual analysis result meets a judgment result of the image evaluation instruction as an answer in question-answer generation.

In some examples, the visual analysis result (relationship label “on”) may be compared with the image evaluation instruction requirement (the relationship should be “placed on the wooden table”). Since “on” matches the requirement and the judgment result is “satisfy”, the generated answer to the “question” in S601 above is “yes”; if the relation label is “near”, the judgment result is “not satisfy”, and the generated answer to the “question” in S601 above is “no”.

S604: obtaining a visual question answering task according to the question and answer in question-answer generation.

In some examples, the visual question answering task is constructed according to the “question-answer pair” formed of the “question” in S601 above and the obtained “answer”. The visual question answering task is: (Question: “Is the apple in the picture placed on a wooden table?”, Answer: “Yes”). At this point, one complete and executed visual question answering task is recorded. Once all visual question answering tasks are recorded, multiple chains of evidence can be formed for subsequent quantifiable evaluation.

In the embodiment of the present disclosure, this embodiment details how to generate the visual question answering task according to the judgment-type interrogative sentence. Specifically, the generation of the visual question answering task can be efficiently completed by combining the judgment-type interrogative sentence with the image evaluation instruction. This method not only improves the quality of question-answer generation, but also ensures the relevance of the visual analysis result to the question, thereby enhancing the accuracy and efficiency of the overall evaluation.

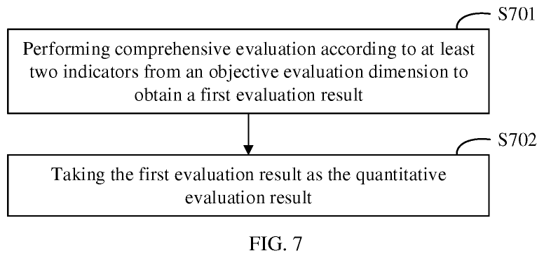

According to an embodiment of the present disclosure, a method for evaluating text-to-image generation is provided. FIG. 7 is a schematic flowchart of the method for evaluating text-to-image generation according to the embodiment of the present disclosure. The step of performing multi-dimensional evaluation according to the visual question answering tasks to obtain a quantitative evaluation result, as shown in FIG. 7, includes:

S701: performing comprehensive evaluation according to at least two indicators from an objective evaluation dimension to obtain a first evaluation result.

In some examples, after all the visual question answering tasks have been completed, the comprehensive evaluation may be performed using two objective indicators, for example: (1) Visual Question Answering Accuracy (VQA Accuracy): calculate the proportion of correct answers to questions in all the visual question answering tasks; (2) Image-Text Semantic Similarity Score (CLIP Score): calculate the cosine similarity between the entire target image and the complete prompt using the Contrastive Language-Image Pre-training (CLIP) model. Different weights may be assigned to the visual question answering accuracy and the image-text semantic similarity score, and the weighted average may be performed to obtain a comprehensive score, which is taken as the first evaluation result.

S702: taking the first evaluation result as the quantitative evaluation result.

In the embodiment of the present disclosure, this embodiment details how to perform multi-dimensional objective evaluation according to the visual question answering tasks. Through multi-dimensional objective evaluation, this embodiment can comprehensively reflect the quality of text-to-image generation. This method not only improves the comprehensiveness of the evaluation, but also ensures the objectivity and quantifiability of the evaluation result.

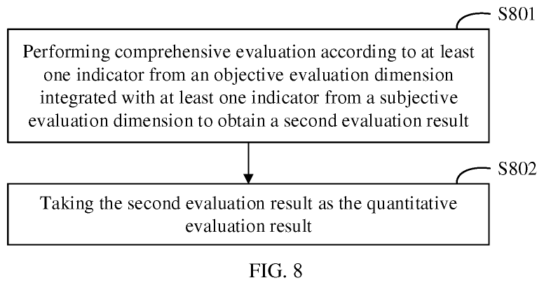

According to an embodiment of the present disclosure, a method for evaluating text-to-image generation is provided. FIG. 8 is a schematic flowchart of the method for evaluating text-to-image generation according to the embodiment of the present disclosure. The step of performing multi-dimensional evaluation according to the visual question answering tasks to obtain a quantitative evaluation result, as shown in FIG. 8, includes:

S801: performing comprehensive evaluation according to at least one indicator from an objective evaluation dimension integrated with at least one indicator from a subjective evaluation dimension to obtain a second evaluation result.

In some examples, after all the visual question answering tasks have been completed, the comprehensive evaluation may be performed using one objective indicator and one subjective indicator, for example: (1) visual question answering accuracy: calculate the proportion of correct answers to questions in all the visual question answering tasks to obtain an objective score; (2) pre-set structured human preference criterion: for example, human preference criterion in the dimension of “aesthetic quality”. A Large Language Model (LLM) may score at multiple levels according to criteria (such as composition and color harmony) to obtain a subjective score, and then fuse the objective score (normalized to 0-1) with the subjective score, for example, by re-weighted averaging, to obtain the second evaluation result. S802: taking the second evaluation result as the quantitative evaluation result.

In the embodiment of the present disclosure, this embodiment details how to combine the objective and subjective evaluation dimensions for comprehensive evaluation. By combining the objective and subjective evaluation dimensions, this embodiment can comprehensively reflect the quality of text-to-image generation. This method not only improves the comprehensiveness of the evaluation, but also ensures the accuracy and reliability of the evaluation result.

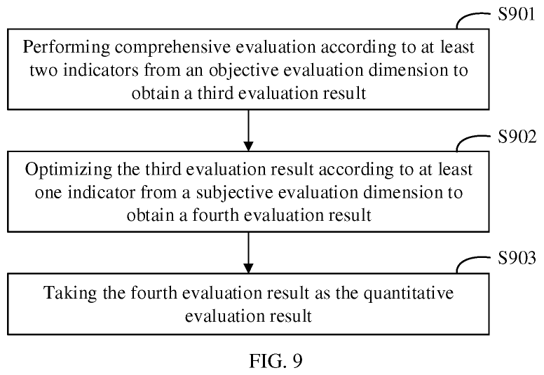

According to an embodiment of the present disclosure, a method for evaluating text-to-image generation is provided. FIG. 9 is a schematic flowchart of the method for evaluating text-to-image generation according to the embodiment of the present disclosure. The step of performing multi-dimensional evaluation according to the visual question answering tasks to obtain a quantitative evaluation result, as shown in FIG. 9, includes:

S901: performing comprehensive evaluation according to at least two indicators from an objective evaluation dimension to obtain a third evaluation result.

In some examples, after all the visual question answering tasks have been completed, the comprehensive evaluation may be performed using two objective indicators, for example: (1) Visual question answering accuracy: calculate the proportion of correct answers to questions in all the visual question answering tasks; (2) Image-text semantic similarity score: calculate the cosine similarity between the entire target image and the complete prompt using the CLIP model. Different weights may be assigned to the visual question answering accuracy and the image-text semantic similarity score, and the weighted average may be performed to obtain a comprehensive score, which is taken as the third evaluation result.

S902: optimizing the third evaluation result according to at least one indicator from a subjective evaluation dimension to obtain a fourth evaluation result.

In some examples, subjective indicators may be introduced to calibrate or correct the objective third evaluation result obtained in S901 above, which may be achieved through a calibration coefficient used for calibration or correction. For example, the LLM may judge whether there is an obvious irrationality (such as a twisted hand or a floating object) in the image according to the “image realism/weirdness” criterion. If the LLM determines that “there is no obvious anomaly, accord with common sense”, then a “positive calibration coefficient” is assigned (for example, “+0.05” is used as the calibration coefficient); if the LLM determines that “there is an obvious anomaly”, then a “negative calibration coefficient” is assigned (for example, “−0.1” is used as the calibration coefficient). Finally, the calibration coefficient is applied to the third evaluation result to obtain the optimized fourth evaluation result.

S903: taking the fourth evaluation result as the quantitative evaluation result.

In the embodiment of the present disclosure, this embodiment details how to optimize the evaluation result through multi-dimensional comprehensive evaluation. Through multi-dimensional comprehensive evaluation and optimization, this embodiment can comprehensively reflect the quality of text-to-image generation. This method not only improves the comprehensiveness of the evaluation, but also ensures the accuracy and reliability of the evaluation result.

The method for evaluating text-to-image generation provided in the above-described embodiments of the present disclosure will be illustrated by examples below.

With the rapid development of text-to-image generation technology, the models' capabilities have been upgraded from simple image generation to understanding and stably executing complex instructions, and are widely used in real-world scenarios such as design, content production, product prototype, education and business. However, the current system for evaluating text-to-image generation lags behind: traditional evaluations mostly focus on low-level visual indicators such as resolution and image clarity, and are difficult to measure the models' true capabilities in complex semantic understanding, complex reasoning, constraint execution and reusability; the manual evaluation is costly, highly subjective and inefficient, and cannot meet the evaluation requirement of rapid model iteration; the existing automated evaluation indicators are single and lack comprehensive coverage of key dimensions such as text rendering accuracy, instruction compliance completeness, and consistency with physical common sense.

The following application example of the embodiments of the present disclosure is an efficient, comprehensive, and objective automated scheme for evaluating the text-to-image generation model. The design purpose is to understand and stably execute complex instructions, and the essence of technology is to use a main controller agent with LLM as core and multiple execution agents (specifically, an execution agent architecture with multi-modular design) for integrated collaboration, along with multi-dimensional quantitative indicators for coordinated evaluation, to form a complete technology chain for automated execution. Specifically, centering on the evaluation main line of “input judgment-preprocessing-instruction parsing-question-answer verification based on visual understanding-result output from multi-indicator scoring”, multiple modules based on various visual and semantic analysis technologies, such as Optical Character Recognition (OCR) module, Visual Question Answering (VQA) module, Image Quality Assessment (IQA) module and CLIP module, are integrated for collaborative work. The decoupling design and collaborative operation mechanism in this modular approach enable the systematic and quantifiable automatic evaluation of key capabilities of text-to-image generation models, such as instruction compliance, text rendering, text-image consistency, image quality and human preference, solving technical problems such as the misalignment between existing evaluation systems and actual capabilities of models, low evaluation efficiency, strong subjectivity and single dimension.

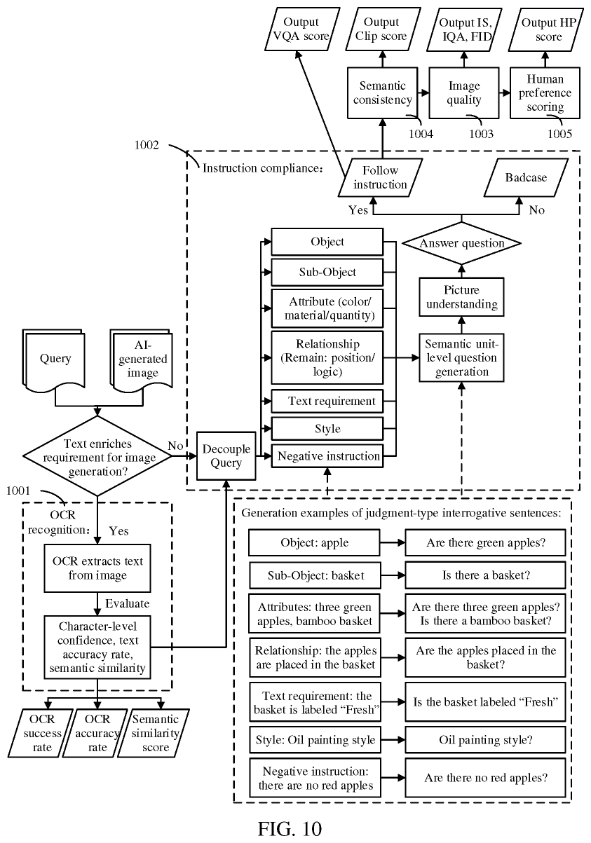

FIG. 10 is a schematic diagram of a workflow of evaluating text-to-image generation in an application example according to an embodiment of the present disclosure. As shown in FIG. 10, the workflow of evaluating text-to-image generation includes:

### (I) Input Judgment: Data Input and Task Judgment Stage

The text Query to be evaluated and its corresponding “target image” (AI-generated image) are received as input. First, it is judged whether the text Query contains a requirement for visible text content in the target image: if so, then the OCR evaluation branch implemented by the OCR module 1001 is triggered; if not, then the instruction parsing process is directly entered. This input judgment mechanism avoids redundant calls to irrelevant modules, thereby improving the overall evaluation efficiency.

### (II) Preprocessing: OCR Preprocessing and Text Consistency Evaluation

When the Query involves the text content in the image, the OCR module 1001 may be called to extract the text information in the image and evaluate the recognition result to obtain the character-level confidence, the text accuracy rate and a semantic similarity score to the original Query; and output the OCR success rate, OCR accuracy rate and semantic similarity score as the independent evaluation result of the text rendering capability.

### (III) Instruction Parsing: Performing Structured Parsing of the Evaluation Request Instruction of the Natural Language Requirement Description

The input text Query may be deeply parsed. The evaluation request instruction is: generate apples, place the apples in a basket, the basket is made of bamboo, the apples are three green apples, the basket is labeled “fresh”, and the style is like an oil painting. Note that “there are no red apples”. This evaluation request instruction needs to be decomposed into multiple pieces of structured semantic information, mainly including:
1. Object;
2. Sub-Object;
3. Attribute information (such as color, material, quantity, etc.);
4. Relationships between objects (positional and logical relationships);
5. Text requirement;
6. Style description;
7. Negative constraint.

The multiple pieces of structured semantic information described above are taken as a unified semantic basis for subsequent question-answer generation and visual understanding.

### (IV) Question-Answer Verification Based on Visual Understanding: Generating a Judgment-Type Interrogative Sentence, and Accordingly Obtaining the Visual Question-Answer Verification of “Question-Answer Pairs” in Visual Question Answering Tasks

A set of judgment-type interrogative sentences corresponding one-to-one with instructions are automatically generated based on the structured instruction information, for example, “Are there green apples?”, “Is there a basket?”, etc. The target image and the judgment-type interrogative sentences are then input together into the VQA module 1002 for reasoning of visual understanding. The output result of the VQA module 1002 is used to judge whether the target image meets all instruction requirements in the evaluation request instruction. If the question-answer result can be clearly determined, the scoring process for instruction compliance is entered; if the question-answer result cannot be determined or the information is missing, this case is marked as Badcase for anomaly analysis.

(V) Result Output from Multi-Indicator Scoring: Multi-Dimensional Scoring and Result Output

Under the premise that the instruction compliance judgment is valid, the following multi-category, multi-dimensional evaluation indicators may be further output:
1. VQA Score: which is used to measure the overall compliance capability of the VQA module 1002 with structured instructions, and is an objective indicator;
2. CLIP score: which is used to evaluate the semantic consistency between text and image, and is an objective indicator;
3. IS, FID and IQA scores: which are used to evaluate the overall image quality and the rationality of the image distribution of the target image, and are objective indicators;
4. Human Preference (HP) score: which is used to measure the overall appeal and usability of the target image to human users in real-world usage scenarios, with a focus on covering subjective dimensions (such as aesthetic quality, compositional rationality, style completion degree, common sense and physical consistency, and creative expression) that are difficult to be fully depicted by automated indicators; and is a subjective indicator.

Finally, the multi-dimensional evaluation indicators described above are integrated to form a quantifiable and complete evaluation result covering the semantic consistency, image quality and subjective preference.

Centering on the evaluation main line “input judgment-preprocessing-instruction parsing-question-answer verification based on visual understanding-result output from multi-indicator scoring” in the workflow of evaluating text-to-image generation described above, multiple modules based on various visual and semantic analysis technologies, such as OCR module, VQA module, IQA module and CLIP module, are integrated for collaborative work. The specific descriptions of all the modules are as follows:
(1) OCR module 1001: extract text information from images through high-precision OCR algorithms, and quantitatively evaluate the quality of text generation from three aspects: character confidence, text accuracy and semantic similarity, providing direct evidence for the text rendering ability of the text-to-image generation model.
(2) VQA module 1002: transform complex instructions into a set of verifiable visual question answering tasks, and achieve the refined evaluation of instruction compliance by judging item by item whether the object, attribute, relationship and negative condition are met.
(3) IQA module 1003: integrate IS, FID and no-reference image quality indicators, quantitatively evaluate the sharpness, diversity and overall quality of the generated image, and perform unified normalization processing.
(4) Semantic consistency module 1004: calculate the semantic matching degree between text and image based on cross-modal models such as CLIP, and focus on the alignment of objects, attributes and details.
(5) Human preference scoring module 1005: based on a real human evaluation process and based on a predefined set of structured human preference scoring criteria (Rubrics), decompose subjective evaluation into several decidable high-level semantic dimensions, as shown in Table 1 below:

TABLE 1

| Dimension | Evaluation point | Judgment criterion |
|---|---|---|
| Spatial structure | Compositional | Clear subject, well-defined hierarchy, and no |
| | rationality | obstruction or conflict |
| World | Common sense | Not violate basic physical/social/realistic |
| understanding | correctness | common sense |
| Physical | Action and | Action conforms to logic of gravity, force and |
| consistency | causality | causality |
| Aesthetic Design | Overall completion | Use of color, lighting, composition, unified |
| | | style, aesthetical typography, reasonable font |
| | | size |
| Style ability | Style matching | Consistent with style specified in prompt |
| | degree | |
| Creative ability | Creativity and | Is there any creative expression beyond |
| | Expression | template? |

Each dimension employs a discrete-level scoring mechanism, accompanied by clear judgment description, to ensure high consistency among different evaluators under the same criteria. This scoring system may be derived from manual annotation experience, as shown in the evaluation criteria in Table 2 below:

TABLE 2

| Dimension | Grading System (0-0.5-1) |
|---|---|
| Spatial Structure \| | \| Meet: clear subject, well-defined hierarchy, no obvious |
| Compositional | obstruction or compositional conflict |
| Rationality | ⊐ Partially meet: subject is slightly cropped or obscured or has |
| | a slightly crowded layout |
| | ┘ Not meet: chaotic subject, missing key element, or serious |
| | compositional conflict |
| World Understanding \| | ┐ Meet: not violate basic physical, social or realistic common |
| Common Sense | sense |
| Correctness | ┘ Partially meet: there are slight common sense deviations |
| | without affecting the overall understanding |
| | ┐ Not meet: obviously violate common sense, and lead to |
| | misunderstanding |
| Physical Consistency \| | ┐ Meet: action, force and causal relationship are reasonable |
| Action and Causality | \| Partially meet: there are slight physical imprecisions, but |
| | they are still understandable |
| | ⊐ Not meet: clearly violate physical law or action logic |
| Aesthetic Design \| | ┐ Meet: picture is complete; and color, lighting and |
| Overall Completion | composition are harmonious and unified |
| | ⊐ Partially meet: overall acceptable but with aesthetic or |
| | layout flaw |
| | \| Not meet: picture is rough, and aesthetic quality is |
| | obviously insufficient |
| Style ability \| Style | ⊐ Meet: highly consistent with style specified in prompt |
| matching degree | \| Partially meet: correct style direction but insufficient |
| | consistency |
| | ┐ Not meet: style is significantly deviated or unrecognizable |
| Creative ability \| | \| Meet: clear creative idea and non-templated output |
| Creativity and | ┘ Partially meet: relatively conventional expression, and |
| Expression | limited creativity |
| | ┘ Not meet: highly templated or lacking effective expression |

In the operational process of evaluation of text-to-image generation, the human scoring criteria do not directly rely on real-time human participation, but are input into the main control agent with LLM as core in the form of scoring rule texts, example precedents and historical scoring samples, so that the large language model learns and internalizes the implicit rules in human aesthetic and preference judgments, thereby simulating the logic of human evaluation during the reasoning stage.

The numerical mapping and weighted fusion are performed on judgment results of the preference dimensions to generate a final HP score. This HP score may be represented as a continuous value or mapped as a level label, and is used for horizontal comparison of models, version iteration monitoring, and result screening, as shown in the criteria for evaluating the total score in Table 3 below:

TABLE 3

| Total score range | Overall conclusion |
|---|---|
| 5.0-6.0 | Excellent picture |
| 3.5-4.5 | Qualified picture |
| 0-3.0 | Unqualified picture |

The use of the workflow of evaluating text-to-image generation in this application example as well as the integrated collaboration of the main control agent with LLM as core and multiple execution agents (specifically, an execution agent architecture with multi-modular design), specifically by integrating multiple modules based on various visual and semantic analysis technologies such as OCR module, VQA module, IQA module and CLIP module for collaborative work, include at least the following technical effects:
(1) Achieve the comprehensive and systematic multi-dimensional evaluation: multiple core dimensions such as text quality, instruction compliance, image quality, text-image alignment and common sense logic are integrated through modular design, covering the core capabilities of the text-to-image generation model, and solving the problem of single evaluation dimension in traditional methods.
(2) Achieve the objective and quantifiable evaluation result: each module adopts quantitative indicators or clear judgment rules, reducing subjective intervention; and the consistency between common sense and logical evaluation is ensured through the standardized judgment logic with LLM as core, solving the problem of strong subjectivity in manual evaluation.
(3) Accuracy of ability to evaluate complex tasks: the effective evaluation of long-text, multi-constraint, complex reasoning generation tasks is realized through the structured question-answer design of the VQA module and the logical reasoning capability of the LLM, solving the problem of insufficient evaluation of complex tasks by traditional automation indicators.
(4) Improve the evaluation efficiency: the entire evaluation process is executed automatically without the need for human intervention, supports rapid evaluation of batch samples to meet the evaluation requirement of high-frequency model iteration, and shortens the model iteration cycle by meeting the high-frequency testing requirement in the model development process.
(5) Reduce the evaluation cost: there is no need to rely on a large number of professional evaluators or crowdsourcing personnel, significantly reducing the human and time costs in the evaluation process, especially suitable for large-scale model optimization and multi-model comparison scenarios.
(6) Improve the objectivity and consistency of evaluation: the subjective bias of manual evaluation is avoided by quantitative indicators and standardized judgment logic, ensuring the consistency and reliability of the evaluation result, and providing objective basis for judgment of model capabilities.
(7) Cover the core capability evaluation requirement in real application scenarios: not only focus on basic visual indicators such as image clarity and resolution, but also cover key capabilities such as instruction compliance, text rendering accuracy, consistency between object and attribute, physical and common sense rationality and human preference, which can more realistically reflect the usability of the text-to-image generation model in actual application scenarios such as design, content production and product prototype.

In some examples of embodiments of the present disclosure, without departing from the overall inventive concept of the embodiments of the present disclosure described above, the following alternatives can be used for some modules or processes, and can also achieve automated evaluation in the embodiments of the present disclosure.
(1) VQA module: which may be replaced by a target detection, attribute recognition or relation extraction model based on rule engine to automatically detect the number of objects, attribute matching and spatial relationship; this method is suitable for evaluation tasks with relatively simple structures and clear rules.
(2) Semantic consistency module: CLIP may be replaced by another cross-modal alignment model, such as a semantic matching model based on dual-tower structure or multimodal encoder, to calculate the semantic similarity between text and image.
(3) Human preference scoring module: which may be replaced by a dedicated scoring model (such as a reward model or preference prediction model) trained by human preference data in some scenarios to output the overall preference score, but the interpretability and adaptability to complex constraints are relatively limited.

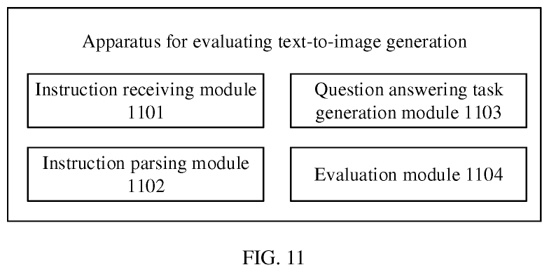

According to an embodiment of the present disclosure, an apparatus for evaluating text-to-image generation is provided. FIG. 11 is a schematic diagram of the composition structure of the apparatus for evaluating text-to-image generation according to the embodiment of the present disclosure. As shown in FIG. 11, the apparatus includes:

an instruction receiving module 1101 configured to receive an evaluation request instruction described in natural language and a target image to be evaluated, where the target image is an image correspondingly generated based on a text described in the natural language;
an instruction parsing module 1102 configured to, when parsing the evaluation request instruction, decompose the natural language description into multiple pieces of structured semantic information based on intent analysis;
a question answering task generation module 1103 configured to obtain a set of visual question answering tasks for evaluation and verification based on the multiple pieces of structured semantic information in combination with visual analysis of the target image; and
an evaluation module 1104 configured to perform multi-dimensional evaluation according to the visual question answering tasks to obtain a quantitative evaluation result.

In one implementation of the embodiment of the present disclosure, the instruction parsing module 1102 is configured to:
extract multiple pieces of key information for evaluation from the natural language description based on the intent analysis; and
decompose the natural language description according to the multiple pieces of key information to obtain the multiple pieces of structured semantic information.

In one implementation of the embodiment of the present disclosure, the multiple pieces of key information includes at least two of: generated object, attribute information, inter-object relationship, text content requirement, style requirement or constraint condition.

In one implementation of the embodiment of the present disclosure, the question answering task generation module 1103 is configured to:

take the multiple pieces of structured semantic information as a unified semantic basis for question-answer generation and visual analysis;

obtain a judgment-type interrogative sentence for question-answer generation according to the multiple pieces of structured semantic information; and

perform the visual analysis of the target image according to the judgment-type interrogative sentence to obtain the visual question answering tasks.

In one implementation of the embodiment of the present disclosure, the question answering task generation module 1103 is configured to:
obtain an image evaluation instruction according to the judgment-type interrogative sentence, and take the judgment-type interrogative sentence as a question in question-answer generation;
trigger the visual analysis of the target image according to the image evaluation instruction to obtain a visual analysis result;
take whether the visual analysis result meets a judgment result of the image evaluation instruction as an answer in question-answer generation; and
obtain the visual question answering tasks according to the question in question-answer generation and the answer in question-answer generation.

In one implementation of the embodiment of the present disclosure, the evaluation module 1104 is configured to:
perform comprehensive evaluation according to at least two indicators from an objective evaluation dimension to obtain a first evaluation result; and
take the first evaluation result as the quantitative evaluation result.

In one implementation of the embodiment of the present disclosure, the evaluation module 1104 is configured to:
perform comprehensive evaluation according to at least one indicator from an objective evaluation dimension integrated with at least one indicator from a subjective evaluation dimension to obtain a second evaluation result; and
take the second evaluation result as the quantitative evaluation result.

In one implementation of the embodiment of the present disclosure, the evaluation module 1104 is configured to:
perform comprehensive evaluation according to at least two indicators from an objective evaluation dimension to obtain a third evaluation result;
optimize the third evaluation result according to at least one indicator from a subjective evaluation dimension to obtain a fourth evaluation result; and
take the fourth evaluation result as the quantitative evaluation result.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of any type of information such as the user's personal information involved are in compliance with relevant laws and regulations, and do not violate public order and good customs.

According to the embodiments of the present disclosure, the present disclosure also provides an electronic device, a readable storage medium and a computer program product.

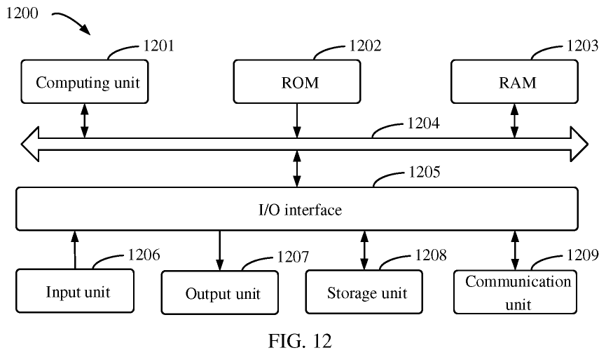

FIG. 12 shows a schematic block diagram of an exemplary electronic device 1200 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 12, the device 1200 includes a computing unit 1201 that may perform various appropriate actions and processes according to a computer program stored in a Read-Only Memory (ROM) 1202 or a computer program loaded from a storage unit 1208 into a Random Access Memory (RAM) 1203. Various programs and data required for the operation of the device 1200 may also be stored in the RAM 1203. The computing unit 1201, the ROM 1202 and the RAM 1203 are connected to each other through a bus 1204. The input/output (I/O) interface 1205 is also connected to the bus 1204.

A plurality of components in the device 1200 are connected to the I/O interface 1205, and include an input unit 1206 such as a keyboard, a mouse, or the like; an output unit 1207 such as various types of displays, speakers, or the like; the storage unit 1208 such as a magnetic disk, an optical disk, or the like; and a communication unit 1209 such as a network card, a modem, a wireless communication transceiver, or the like. The communication unit 1209 allows the device 1200 to exchange information/data with other devices through a computer network such as the Internet and/or various telecommunication networks.

The computing unit 1201 may be various general-purpose and/or special-purpose processing components with processing and computing capabilities. Some examples of the computing unit 1201 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1201 performs various methods and processes described above, such as the method for evaluating text-to-image generation. For example, in some implementations, the method for evaluating text-to-image generation may be implemented as a computer software program tangibly contained in a computer-readable medium, such as the storage unit 1208. In some implementations, a part or all of the computer program may be loaded and/or installed on the device 1200 via the ROM 1202 and/or the communication unit 1209. When the computer program is loaded into RAM 1203 and executed by the computing unit 1201, one or more steps of the method for evaluating text-to-image generation described above may be performed. Alternatively, in other implementations, the computing unit 1201 may be configured to perform the method for evaluating text-to-image generation by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for evaluating text-to-image generation, comprising:
receiving an evaluation request instruction described in natural language and a target image to be evaluated, wherein the target image is an image correspondingly generated based on a text described in the natural language;
in a case of the evaluation request instruction is parsed, decomposing the natural language description into multiple pieces of structured semantic information based on intent analysis;
obtaining a set of visual question answering tasks for evaluation and verification based on the multiple pieces of structured semantic information in combination with visual analysis of the target image; and
performing multi-dimensional evaluation according to the visual question answering tasks to obtain a quantitative evaluation result.

2. The method of claim 1, wherein the decomposing of the natural language description into the multiple pieces of structured semantic information based on the intent analysis, comprises:
extracting multiple pieces of key information for evaluation from the natural language description based on the intent analysis; and
decomposing the natural language description according to the multiple pieces of key information to obtain the multiple pieces of structured semantic information;
wherein the multiple pieces of key information comprise at least two of: generated object, attribute information, inter-object relationship, text content requirement, style requirement or constraint condition.

3. The method of claim 1, wherein the obtaining of the set of visual question answering tasks for evaluation and verification based on the multiple pieces of structured semantic information in combination with the visual analysis of the target image, comprises:
taking the multiple pieces of structured semantic information as a unified semantic basis for question-answer generation and visual analysis;
obtaining a judgment-type interrogative sentence for question-answer generation according to the multiple pieces of structured semantic information; and
performing the visual analysis of the target image according to the judgment-type interrogative sentence to obtain the visual question answering tasks.

4. The method of claim 3, wherein the performing of the visual analysis of the target image according to the judgment-type interrogative sentence to obtain the visual question answering tasks, comprises:
obtaining an image evaluation instruction according to the judgment-type interrogative sentence, and taking the judgment-type interrogative sentence as a question in question-answer generation;
triggering the visual analysis of the target image according to the image evaluation instruction to obtain a visual analysis result;
taking whether the visual analysis result meets a judgment result of the image evaluation instruction as an answer in question-answer generation; and
obtaining the visual question answering tasks according to the question in question-answer generation and the answer in question-answer generation.

5. The method of claim 1, wherein the performing of the multi-dimensional evaluation according to the visual question answering tasks to obtain the quantitative evaluation result, comprises:
performing comprehensive evaluation according to at least two indicators from an objective evaluation dimension to obtain a first evaluation result; and
taking the first evaluation result as the quantitative evaluation result.

6. The method of claim 1, wherein the performing of the multi-dimensional evaluation according to the visual question answering tasks to obtain the quantitative evaluation result, comprises:
performing comprehensive evaluation according to at least one indicator from an objective evaluation dimension integrated with at least one indicator from a subjective evaluation dimension to obtain a second evaluation result; and
taking the second evaluation result as the quantitative evaluation result.

7. The method of claim 1, wherein the performing of the multi-dimensional evaluation according to the visual question answering tasks to obtain the quantitative evaluation result, comprises:
performing comprehensive evaluation according to at least two indicators from an objective evaluation dimension to obtain a third evaluation result;
optimizing the third evaluation result according to at least one indicator from a subjective evaluation dimension to obtain a fourth evaluation result; and
taking the fourth evaluation result as the quantitative evaluation result.

8. An electronic device, comprising:
at least one processor; and
a memory connected in communication with the at least one processor;
wherein the memory stores an instruction executable by the at least one processor, and the instruction, when executed by the at least one processor, enables the at least one processor to execute:
receiving an evaluation request instruction described in natural language and a target image to be evaluated, wherein the target image is an image correspondingly generated based on a text described in the natural language;
in a case of the evaluation request instruction is parsed, decomposing the natural language description into multiple pieces of structured semantic information based on intent analysis;
obtaining a set of visual question answering tasks for evaluation and verification based on the multiple pieces of structured semantic information in combination with visual analysis of the target image; and
performing multi-dimensional evaluation according to the visual question answering tasks to obtain a quantitative evaluation result.

9. The electronic device of claim 8, wherein the instruction, when executed by the at least one processor, enables the at least one processor to execute the decomposing of the natural language description into the multiple pieces of structured semantic information based on the intent analysis, by:
extracting multiple pieces of key information for evaluation from the natural language description based on the intent analysis; and
decomposing the natural language description according to the multiple pieces of key information to obtain the multiple pieces of structured semantic information;
wherein the multiple pieces of key information comprise at least two of: generated object, attribute information, inter-object relationship, text content requirement, style requirement or constraint condition.

10. The electronic device of claim 8, wherein the instruction, when executed by the at least one processor, enables the at least one processor to execute the obtaining of the set of visual question answering tasks for evaluation and verification based on the multiple pieces of structured semantic information in combination with the visual analysis of the target image, by:
taking the multiple pieces of structured semantic information as a unified semantic basis for question-answer generation and visual analysis;
obtaining a judgment-type interrogative sentence for question-answer generation according to the multiple pieces of structured semantic information; and
performing the visual analysis of the target image according to the judgment-type interrogative sentence to obtain the visual question answering tasks.

11. The electronic device of claim 10, wherein the instruction, when executed by the at least one processor, enables the at least one processor to execute the performing of the visual analysis of the target image according to the judgment-type interrogative sentence to obtain the visual question answering tasks, by:
obtaining an image evaluation instruction according to the judgment-type interrogative sentence, and taking the judgment-type interrogative sentence as a question in question-answer generation;
triggering the visual analysis of the target image according to the image evaluation instruction to obtain a visual analysis result;
taking whether the visual analysis result meets a judgment result of the image evaluation instruction as an answer in question-answer generation; and
obtaining the visual question answering tasks according to the question in question-answer generation and the answer in question-answer generation.

12. The electronic device of claim 8, wherein the instruction, when executed by the at least one processor, enables the at least one processor to execute the performing of the multi-dimensional evaluation according to the visual question answering tasks to obtain the quantitative evaluation result, by:
performing comprehensive evaluation according to at least two indicators from an objective evaluation dimension to obtain a first evaluation result; and
taking the first evaluation result as the quantitative evaluation result.

13. The electronic device of claim 8, wherein the instruction, when executed by the at least one processor, enables the at least one processor to execute the performing of the multi-dimensional evaluation according to the visual question answering tasks to obtain the quantitative evaluation result, by:
performing comprehensive evaluation according to at least one indicator from an objective evaluation dimension integrated with at least one indicator from a subjective evaluation dimension to obtain a second evaluation result; and
taking the second evaluation result as the quantitative evaluation result.

14. The electronic device of claim 8, wherein the instruction, when executed by the at least one processor, enables the at least one processor to execute the performing of the multi-dimensional evaluation according to the visual question answering tasks to obtain the quantitative evaluation result, by:
performing comprehensive evaluation according to at least two indicators from an objective evaluation dimension to obtain a third evaluation result;
optimizing the third evaluation result according to at least one indicator from a subjective evaluation dimension to obtain a fourth evaluation result; and
taking the fourth evaluation result as the quantitative evaluation result.

15. A non-transitory computer-readable storage medium storing a computer instruction thereon, wherein the computer instruction is used to cause a computer to execute:
receiving an evaluation request instruction described in natural language and a target image to be evaluated, wherein the target image is an image correspondingly generated based on a text described in the natural language;
in a case of the evaluation request instruction is parsed, decomposing the natural language description into multiple pieces of structured semantic information based on intent analysis;
obtaining a set of visual question answering tasks for evaluation and verification based on the multiple pieces of structured semantic information in combination with visual analysis of the target image; and
performing multi-dimensional evaluation according to the visual question answering tasks to obtain a quantitative evaluation result.

16. The non-transitory computer-readable storage medium of claim 15, wherein the computer instruction is used to cause the computer to execute the decomposing of the natural language description into the multiple pieces of structured semantic information based on the intent analysis, by:
extracting multiple pieces of key information for evaluation from the natural language description based on the intent analysis; and
decomposing the natural language description according to the multiple pieces of key information to obtain the multiple pieces of structured semantic information;
wherein the multiple pieces of key information comprise at least two of: generated object, attribute information, inter-object relationship, text content requirement, style requirement or constraint condition.

17. The non-transitory computer-readable storage medium of claim 15, wherein the computer instruction is used to cause the computer to execute the obtaining of the set of visual question answering tasks for evaluation and verification based on the multiple pieces of structured semantic information in combination with the visual analysis of the target image, by:
taking the multiple pieces of structured semantic information as a unified semantic basis for question-answer generation and visual analysis;
obtaining a judgment-type interrogative sentence for question-answer generation according to the multiple pieces of structured semantic information; and
performing the visual analysis of the target image according to the judgment-type interrogative sentence to obtain the visual question answering tasks.

18. The non-transitory computer-readable storage medium of claim 17, wherein the computer instruction is used to cause the computer to execute the performing of the visual analysis of the target image according to the judgment-type interrogative sentence to obtain the visual question answering tasks, by:
obtaining an image evaluation instruction according to the judgment-type interrogative sentence, and taking the judgment-type interrogative sentence as a question in question-answer generation;
triggering the visual analysis of the target image according to the image evaluation instruction to obtain a visual analysis result;
taking whether the visual analysis result meets a judgment result of the image evaluation instruction as an answer in question-answer generation; and
obtaining the visual question answering tasks according to the question in question-answer generation and the answer in question-answer generation.

19. The non-transitory computer-readable storage medium of claim 15, wherein the computer instruction is used to cause the computer to execute the performing of the multi-dimensional evaluation according to the visual question answering tasks to obtain the quantitative evaluation result, by:
performing comprehensive evaluation according to at least two indicators from an objective evaluation dimension to obtain a first evaluation result; and
taking the first evaluation result as the quantitative evaluation result.

20. The non-transitory computer-readable storage medium of claim 15, wherein the computer instruction is used to cause the computer to execute the performing of the multi-dimensional evaluation according to the visual question answering tasks to obtain the quantitative evaluation result, by:
performing comprehensive evaluation according to at least one indicator from an objective evaluation dimension integrated with at least one indicator from a subjective evaluation dimension to obtain a second evaluation result; and
taking the second evaluation result as the quantitative evaluation result.
